(19) United States
(12) Patent Application Publication
(10) Pub. No.: US 2020/0369855 A1
(43) Pub. Date: Nov. 26, 2020

(54) LOW LOSS, COMPOSITE LAYER AND A COMPOSITION FOR FORMING THE SAME

(71) Applicant: ROGERS CORPORATION, Chandler, AZ (US)

(72) Inventors: Thomas A. Koes, Riverside, CA (US); Nazeef Azam, Ellington, CT (US); Bryan Tworzydlo, Dayville, CT (US); Matthew Raymond Himes, Bear, DE (US); William Blasius, Charlton, MA (US)

(21) Appl. No.: 16/878,855

(22) Filed: May 20, 2020

Related U.S. Application Data
(60) Provisional application No. 62/851,846, filed on May 23, 2019.

(51) Int. Cl. C08K 9/04; C08F 277/00; C08K 3/36; C08K 5/101; C08K 5/03; B32B 27/06; B32B 27/32

(52) U.S. Cl. CPC C08K 9/04; C08F 277/00; C08K 3/36; C08K 5/101; B32B 2457/00; B32B 27/06; B32B 27/32; C08F 2500/25; C08K 5/03

(57) ABSTRACT

In an aspect, a composition comprises a hydrocarbyl thermoplastic polymer comprising repeat units derived from an alpha-olefin and a C₄₋₃₀ cycloalkene; a reactive monomer which is free-radically crosslinkable to produce a crosslinked network; a free radical source; and a functionalized fused silica capable of chemically coupling to the crosslinked network.

### CROSS-REFERENCE TO RELATED APPLICATION

This application claims the benefit of U.S. Provisional Patent Application Ser. No. 62/851,846 filed May 23, 2019. The related application is incorporated herein in its entirety by reference.

### BACKGROUND

This application relates to a low loss, composite layer. Laminates and prepreg systems employed in cellular telecommunications, laminate-based chip carriers, high speed digital servers, and the like, must meet a number of physical and electrical performance criteria, for example, a low loss, a low permittivity, good heat resistance, good dimensional stability, and the like. Such systems are continuously trending towards smaller and smaller components, demanding higher performance requiring improvements at every level. There accordingly remains a need for improved materials for use in circuit materials. Specifically, there is a need for improvements that include increased peel strengths, for example, to extremely low profile metal foils. It would be a further advantage to achieve further reduced dielectric loss values, among other desired electrical, thermal, and physical properties.

### BRIEF SUMMARY

Disclosed herein is a low loss dielectric layer and a composition for forming the same.

In an aspect, a composition comprises a hydrocarbyl thermoplastic polymer; a reactive monomer that is free-radically crosslinkable to produce a crosslinked network; a free radical source; and a functionalized fused silica that is capable of chemically coupling to the crosslinked network.

In another aspect, a composite layer can be derived from the composition.

In an aspect, a method of making the composite layer comprises forming a layer from the composition; and polymerizing the reactive monomer in the composition to form the crosslinked network.

In another aspect, a multilayer article comprises the composite layer.

The above described and other features are exemplified by the following figures, detailed description, and claims.

### BRIEF DESCRIPTION OF THE DRAWINGS

The following figures are exemplary aspects, which are provided to illustrate the present disclosure. The figures are illustrative of the examples, which are not intended to limit devices made in accordance with the disclosure to the materials, conditions, or process parameters set forth herein.

FIG. 1 is a graphical illustration of the minimum melt viscosity and the coefficient of thermal expansion values with filler content;

FIG. 2 is a scanning electron microscope of a composition of the examples comprising a fused silica; and

FIG. 3 is a scanning electron microscope of a composition of the examples comprising a methacrylated fused silica.

### DETAILED DESCRIPTION

A dielectric composition for bond ply layers for use in multi-layered printed circuit boards needs to have a low enough minimum melt viscosity such that it can sufficiently flow into and fill the surface topographies associated with adjacent signal and/or ground layers, while maintaining a low coefficient of thermal expansion in the z-axis to ensure high reliability of plated through-holes. As these two characteristics are usually diametrically opposed, achieving a dielectric composition having an optimum balance between the minimum melt viscosity and the coefficient of thermal expansion has been difficult. A composition for forming a composite layer has been developed that can not only achieve a good balance between the minimum melt viscosity and the coefficient of thermal expansion, but can also exhibit at least one of a low loss or a high peel strength to copper. The composition comprises a hydrocarbyl thermoplastic polymer; a reactive monomer that is free-radically crosslinkable to produce a crosslinked network; a free radical source; and a functionalized fused silica.

The presence of the functionalized fused silica in the composite layer was found to have a greater peel strength to copper as compared to composite layers formed from the same composition except comprising a fused silica free of the functionality. For example, the composite layer can achieve a high peel strength to copper of greater than or equal to 0.54 kilograms per centimeter (kg/cm). The presence of the functionalized fused silica in the composite layer was also found to result in a decrease in the average coefficient of thermal expansion in the z-direction, even without the presence of a reinforcing layer, as compared to composite layers formed from the same composition except comprising a fused silica free of the functionality. Further regarding reinforcing layers, unlike bond ply layers that require a woven or nonwoven reinforcement to be viable, the present composite layer also has the benefit that it can be unreinforced and can be made relatively thinner. Additionally, the composite layer formed from the composition can exhibit a low dielectric loss of less than or equal to 0.0030 at 10 gigahertz (GHz).

The composition comprises a hydrocarbyl thermoplastic polymer. As used herein, the term “hydrocarbyl thermoplastic polymer” refers to a polymer that is prepared from the addition polymerization of at least one non-heteroatom containing, unsaturated hydrocarbon. The hydrocarbyl thermoplastic polymer can be non-reactive with the other components of the composition. The hydrocarbyl thermoplastic polymer can be derived from at least one of an alpha-olefin or a cyclic olefin. The alpha-olefin can comprise at least one C₂₋₂₀ alkene, for example, ethene, propene, 1-butene, or 1-decene. The cyclic olefin can comprise at least one C₄₋₃₀ cycloalkene, for example, cyclobutene, cyclopentene, cycloheptene, cyclooctene, cyclodecene, norbornene or other alkyl- or aryl-substituted norbornenes (such as 5-methyl-2-norbornene, 5-hexyl-2-norbornene, 5-phenyl-2-norbornene, 5-ethyl-2-norbornene, 4,5-dimethyl-2-norbornene, or exo-1,4,4a,9,9a,10-hexahydro-9,10(1′,2′)-benzeno-1,4-methanoanthracene (HBMN)). Other cyclic olefins include tricyclic monomers (for example, exo-dihydrodicyclopentadiene) or tetracyclic monomers (for example, endo,exo-tetracyclododecene). Any residual unsaturations on the hydrocarbyl polymer can be removed by hydrogenation prior to incorporation into the composition.

The hydrocarbyl thermoplastic polymer can have the Formula (I),

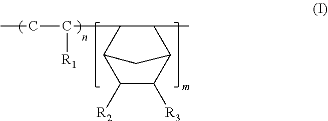

wherein R₁, R₂, and R₃ can each independently be H, a C₁₋₃₀ alkyl group, or a C₆₋₃₀ aryl group; n can be 0 to 3,500, or 10 to 2,500, or 100 to 1,000; and m can be 1 to 5,300, or 100 to 3,000, or 1,000 to 3,000. R₁ can be H, a C₁₋₃₀ alkyl group, or a C₆₋₃₀ aryl group and R₂ and R₃ can each independently be H, a C₁₋₂₃ alkyl group, or a C₆₋₂₃ aryl group. A molar ratio of the cyclic olefin (for example, of the C₄₋₃₀ cycloalkene) repeat units to the alpha-olefin repeat units in the hydrocarbyl thermoplastic polymer can be 6:1 to 0.5:1, or 6:1 to 1.5:1.

The cyclic olefin can comprise a functional group, for example, at least one of an alkyl group (for example, a methyl group, an ethyl group, a propyl group, or a butyl group). The cyclic olefin can comprise a cyclic alkyl functional group (for example, bicyclo [2.2.1] hept-2-ene, 6-methylbicyclo [2.2.1] hept-2-ene, 5, 6-dimethylbicyclo [2.2.1]-hept-2-ene, 1-methylbicyclo [2.2.1] hept-2-ene, 6-ethylbicyclo [2.2.1] hept-2-ene). The cyclic olefin can comprise a tetra-cyclic alkyl functional group (for example, tetracyclo [4.4.0.1^{2,5}.1^{7,10}]-3-dodecene, 8-methyltetracyclo [4.4.0.1^{2,5}.1^{7,10}]-3-dodecene, 8-ethyltetracyclo [4.4.0.1^{2,5}.1^{7,10}]-3-dodecene, 8,9-dimethyltetracyclo [4.4.0.1^{2,5}.1^{7,10}]-3-dodecene, 8-methyl-9-ethyltetracyclo [4.4.0.1^{2,5}.1^{7,10}]-3-dodecene, or 8-strearyltetracyclo [4.4.0.1^{2,5}.1^{7,10}]-3-dodecene). The cyclic olefin can comprise an aryl group (for example, a phenyl group, a tolyl group, or a naphthyl group), or a heteroatom containing group (for example, a nitrile group or a halogen). The functionalized cyclic olefin repeat unit can be present in the hydrocarbyl thermoplastic polymer in an amount of 5 to 45 wt %, or 35 to 75 wt %, or 65 to 85 wt % based on the total weight of the hydrocarbyl thermoplastic polymer.

The alpha-olefin can comprise a functional group such as at least one of an alkyl group, an aryl group (for example, a phenyl group, a tolyl group, or a naphthyl group), or a heteroatom containing group (for example, a nitrile group, or a halogen). The functionalized alpha-olefin repeat unit can be present in the hydrocarbyl thermoplastic polymer in an amount of 55 to 95 wt %, or 25 to 65 wt %, or 15 to 35 wt % based on the total weight of the hydrocarbyl thermoplastic polymer.

Single-site catalysts such as highly active metallocenes, constrained geometry catalysts (CGC), nickel or palladium diimine complexes used in combination with methylaluminoxane (MAO) or borate co-catalysts can enable copolymerization of cyclic olefins with alpha-olefins such as ethene or propene.

The composition can comprise 10 to 90 volume percent (vol %), or 25 to 75 vol %, or 30 to 50 vol % of the hydrocarbyl thermoplastic polymer based on the total volume of the composition. As used herein, when referring to the amount of a component in weight percent or volume percent based on the total volume of the composition, the amount is based on the total amount of the solids, i.e., minus any solvent present and is also based on the total amount minus any reinforcing fabric present (for example, a woven or non-woven fabric). A weight average molecular weight of the hydrocarbyl thermoplastic polymer can be 500 to 105,000 grams per mole (g/mol), or 3,000 to 100,000 g/mol, or 20,000 to 90,000 g/mol, or 70,000 to 90,000 g/mol based on polystyrene standards.

The composition comprises a reactive monomer that is capable of crosslinking to produce a crosslinked network. The reactive monomer can comprise at least one of a di-allylic compound, a tri-allylic compound, a di-vinylic compound, a tri-vinylic compound, a conjugated diene, a non-conjugated diene, a di(meth)acrylate compound, or a tri(meth)acrylate compound. The reactive monomer can comprise at least one of triallyl (iso)cyanurate, 1,9-decadiene, 1,7-octadiene, tris(2-hydroxyethyl) isocyanurate triacrylate (THEIC TA), or trimethylolpropane trimethacrylate (TMP TMA). The reactive monomer can comprise a triallyl (iso)cyanurate. As used herein, the triallyl (iso)cyanurate comprises at least one of triallyl isocyanurate or triallyl cyanurate as illustrated in Formula (2A) and Formula (2B), respectively.

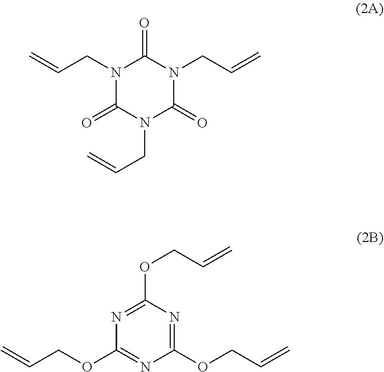

The composition can comprise 1 to 35 vol %, or 5 to 25 vol %, or 5 to 15 vol % of the reactive monomer based on the total volume of the composition. A volume ratio of the hydrocarbyl thermoplastic polymer and the reactive monomer can be 1:1 to 50:1, or 1:1 to 10:1, or 2:1 to 5:1.

The composition can comprise a free radical source (also referred to herein as an initiator), for example, that can be thermally activated. Examples of free radical sources that are capable of being activated thermally include peroxides, azo compounds (for example, α,α′-azobis(isobutyronitrile)), redox initiators (for example, a combination of a peroxides such as H₂O₂ and a ferrous salt), or azides (for example, acetyl azide). The free radical source can comprise at least one of a peroxide initiator, an azo initiator, a carbon-carbon initiator, a persulfate initiator, a hydrazine initiator, a hydrazide initiator, or a halogen initiator. The free radical source can comprise at least one of 2,3-dimethyl-2,3-diphenylbutane, 3,4-dimethyl-3,4-diphenylhexane, or 1,4-diisopropylbenzene. The free radical source can comprise an organic peroxide, for example, at least one of dicumyl peroxide, t-butyl perbenzoate, α,α′-di-(t-butyl peroxy) diisopropylbenzene, or 2,5-dimethyl-2,5-di(t-butylperoxy)-3-hexyne.

The free radical source can comprise a peroxide that has a decomposition temperature of at least 50 degrees Celsius (° C.). Examples of peroxides include ketone peroxides (for example, methyl ethyl ketone peroxide or cyclohexanone peroxide), peroxyketals (for example, 1,1-bis(t-butyl peroxy)-3,3,5-trimethylcyclohexane or 2,2-bis(t-butyl peroxy)butane), hydroperoxides (for example, t-butyl hydroperoxide or 2,5-dimethylhexane-2,5-dihydroperoxide), dialkyl peroxides (for example, dicumyl peroxide, 2,5-dimethyl-2,5-di(t-butyl peroxy)hexyne-3, or α,α′-bis(t-butyl peroxy-m-isopropyl)benzene), diacyl peroxides (for example, octanoyl peroxide or isobutyryl peroxide), or peroxycarbonates (for example, a peroxydicarbonate such as di(4-tert-butylcyclohexyl) peroxydicarbonate)).

The composition can comprise 0.01 to 10 vol %, or 0.05 to 3 vol %, or 0.1 to 2 vol %, or 0.5 to 1 vol % of the free radical source based on the total weight of the composition.

The composition comprises a functionalized fused silica. The composition can comprise 10 to 70 vol %, or 20 to 60 vol %, or 40 to 55 vol %, or 10 to 40 vol % of the functionalized fused silica based on the total volume of the composition. The functionalized fused silica can have a spherical morphology having an average diameter of 1 to 50 micrometers, or 1 to 10 micrometers.

The composition can comprise a hydrocarbyl thermoplastic polymer comprising repeat units derived from an alpha-olefin and a C₄₋₃₀ cycloalkene; a reactive monomer that is free-radically crosslinkable to produce a crosslinked network; a free radical source; and a functionalized fused silica that is capable of chemically coupling to the crosslinked network. The hydrocarbyl thermoplastic polymer can comprise repeat units derived from at least one of cyclobutene, cyclopentene, cycloheptene, cyclooctene, cyclodecene, norbornene, or an alkyl- or aryl-substituted norbornene (such as 5-methyl-2-norbornene, 5-hexyl-2-norbornene, 5-phenyl-2-norbornene, 5-ethyl-2-norbornene, 4,5-dimethyl-2-norbornene, exo-1,4,4a,9,9a,10-hexahydro-9,10(1′,2′)-benzeno-1,4-methanoanthracene, exo-dihydrodicyclopentadiene, or endo,exo-tetracyclododecene). The hydrocarbyl thermoplastic polymer can have the Formula (I). A molar ratio of the C₄₋₃₀ cycloalkene repeat units to the alpha-olefin repeat units to can be 6:1 to 0.5:1, or 6:1 to 1.5:1.0. A weight average molecular weight of the hydrocarbyl thermoplastic polymer can be 500 to 105,000 grams per mole based on polystyrene standards. The reactive monomer can comprise a triallyl (iso)cyanurate. The free radical source can comprise at least one of dicumyl peroxide, dimethyl diphenyl hexane, methyl ethyl ketone peroxide, cyclohexanone peroxide, 1,1-bis(t-butyl peroxy)-3,3,5-trimethylcyclohexane, 2,2-bis(t-butyl peroxy)butane), t-butyl hydroperoxide, 2,5-dimethylhexane-2,5-dihydroperoxide, 2,5-dimethyl-2,5-di(t-butyl peroxy)hexyne-3, t-butyl perbenzoate, a, a′-di-(t-butyl peroxy) diisopropylbenzene, or 2,5-dimethyl-2,5-di(t-butylperoxy)-3-hexyne, α,α′-bis(t-butyl peroxy-m-isopropyl)benzene), octanoyl peroxide, isobutyryl peroxide), peroxydicarbonate, α,α′-azobis(isobutyronitrile), a redox initiator, acetyl azide, 2,3-dimethyl-2,3-diphenylbutane, 3,4-dimethyl-3,4-diphenylhexane, or 1,4-diisopropylbenzene. The composition can comprise a hydrocarbon resin diluent. The hydrocarbon resin diluent can have a weight average molecular weight of 200 to 2,000 grams per mole based on polystyrene standards. The hydrocarbon resin diluent can be derived from piperylene and optionally an aromatic repeat unit. The hydrocarbon resin diluent can be saturated. The composition can comprise a flame retardant. A functional group of the functionalized fused silica can comprise at least one of a (meth)acrylate group, a vinyl group, an allyl group, a propargyl group, a butenyl group, or a styryl group.

The composition can comprise 10 to 90 volume percent, or 25 to 75 volume percent, or 30 to 50 volume percent of the hydrocarbyl thermoplastic polymer based on the total volume of the composition. The composition can comprise 0.1 to 2 volume percent, or 0.5 to 1 volume percent of the free radical source based on the total weight of the composition. The composition can comprise 1 to 35 volume percent, or 5 to 25 volume percent, or 5 to 15 volume percent of the reactive monomer based on the total volume of the composition. The composition can comprise 10 to 70 volume percent, or 20 to 60 volume percent, or 40 to 55 volume percent of the functionalized fused silica based on the total volume of the composition. The composition can comprise 0 to 50 volume percent, or 10 to 40 volume percent, or 5 to 30 volume percent of the hydrocarbon resin diluent based on the total volume of the composition. The composition can comprise 5 to 25 volume percent, or 8 to 20 volume percent of a flame retardant based on the total volume of the composition.

The functionalized fused silica can be prepared by reacting a silane comprising a functional group. The functional group can comprise at least one of a (meth)acrylate group, a vinyl group, an allyl group, a propargyl group, a butenyl group, or a styryl group. Examples of (meth)acrylate functional silanes include (3-acryloxypropyl)trimethoxy-silane, n-(3-acryloxy-2-hydroxypropyl)-3-aminopropyltriethoxysilane, (3-acryloxypropyl)methyldimethoxysilane, methacryloxypropyltrimethoxysilane, o-(methacryloxyethyl)-n-(triethoxy-silylpropyl)urethane, n-(3-methacryloxy-2-hydroxypropyl)-3-aminopropyltriethoxysilane, methacryloxymethyltriethoxysilane, methacryloxymethyltrimethoxysilane, methacryloxypropyltriethoxysilane, (methacryloxymethyl)methyldiethoxysilane, (methacryloxymethyl)methyldimethoxysilane, methacryloxypropylmethyldiethoxysilane, methacryloxypropylmethyldimethoxysilane, methacryloxypropyldimethylethoxysilane, or methacryloxypropyldimethylmethoxysilane. Examples of vinyl functional silanes include vinyltriacetoxysilane, vinyltriethoxysilane, vinyltriisopropenoxysilane, vinyltriisopropoxysilane, vinyltrimethoxysilane, vinyltris(2-methoxyethoxy)silane, vinyltris(methylethylketoximino)silane, (divinylmethylsilylethyl)triethoxysilane, docosenyltriethoxysilane, hexadecafluorododec-11-enyl-1-trimethoxysilane, hexenyltriethoxysilane, 7-octenyltrimethoxysilane, 0-undecenyltrimethoxysilane, o-(vinyloxybutyl)-n-(triethoxysilyl-propyl)urethane, vinyltri-t-butoxysilane, vinyltris(methoxypropoxy)silane, vinylmethyldiethoxysilane, vinylmethyldimethoxysilane, vinyldimethylethoxysilane, trivinylmethoxysilane, bis(triethoxysilylethyl)vinylmethyl-silane, triethoxysilyl modified poly-1,2-butadiene, or diethoxymethylsilyl modified poly-1,2-butadiene. Examples of allyl functional silanes include 3-(n-allylamino)propyltrimethoxy silane, n-allyl-aza-2,2-dimethoxysilacyclopentane, allyltrimethoxysilane, allyloxyundecyltrimethoxysilane, allyltriethoxysilane, or 2-(chloromethyl)allyltrimethoxysilane. An example of a propargyl functional silane includes o-(propargyloxy)-n-(triethoxy-silylpropyl)urethane. An example of a butenyl functional silane includes butenyltriethoxysilane. Examples of styryl functional silanes include 3-(n-styrylmethyl-2-aminoethylamino)propyltrimethoxysilane or styrylethyltrimethoxysilane. An example of a cyclopentadienyl functional silane includes (3-cyclopentadienylpropyl)trimethoxysilane. Examples of cyclohexenyl functional silanes include [2-(3-cyclohexenyl)ethyl]trimethoxysilane or [2-(3-cyclohexenyl)ethyl]trimethoxysilane. The functional silane can comprise a methacrylsilane such as at least one of γ-methacryloxypropyl methyldimethoxy silane, γ-methacryloxypropyl trimethoxy silane, γ-methacryloxypropyl methyldiethoxy silane, or γ-methacryloxypropyl triethoxy silane.

The composition can comprise a hydrocarbon resin diluent. The hydrocarbon resin diluent can comprise an amorphous thermoplastic oligomer or polymer produced by the polymerization of unsaturated hydrocarbons. As used herein, the hydrocarbon resin diluent oligomer can have a weight average molecular weight of less than or equal 2,500 g/mol based on polystyrene standards. The hydrocarbon resin diluent can result in at least one of a reduced minimum melt viscosity, an enhanced resin flow, or an improved leveling.

The hydrocarbon resin diluent can comprise a C₂₋₉ hydrocarbon resin diluent. The hydrocarbon resin diluent can be derived from at least one of an aliphatic C₂₋₉ hydrocarbon or an aromatic C₆₋₉ hydrocarbon. The hydrocarbon resin diluent can be saturated. The hydrocarbon resin diluent can be free (or can comprise 0 mole percent) of repeat units derived from a C₅₋₂₅ cycloalkene. The hydrocarbon resin diluent can comprise a repeat unit derived from a cyclooctene.

The hydrocarbon resin diluent can comprise a polybutene (for example, an oligomeric polybutene). Oligomers of C₄ olefins (primarily isobutene) are commercially available in a wide range of weight average molecular weights. Short chain-length polybutenes are free-flowing; medium chain-length polybutenes are sticky with a honey-like consistency, while those with the longest chain length are very tacky, semi-solids. Examples of polybutenes include INDOPOL™ commercially available from INEOS Oligomers, London and PANALANE™ commercially available from Vantage Specialty Ingredients, Inc., Warren, N.J.

The hydrocarbon resin diluent can comprise a C₅ hydrocarbon resin diluent that can be prepared from at least one of piperylene or its derivatives such as cis/trans 1,3-pentadiene, 2-methyl-2-butene, cyclopentene, cyclopentadiene (CPD), or dicyclopentadiene (DCPD). Piperylene monomers and derivatives thereof can be cationically polymerized using Lewis acid catalysts to produce oligomeric resins with low-to-high softening points. The C₅ hydrocarbon resin diluent can be primarily aliphatic and can therefore be compatible with at least one of natural rubber, styrene-isoprene-styrene (SIS) copolymer, amorphous polyolefin (APO) (for example, amorphous polyalpha-olefin (APAO)), polyolefin (such as low density polyethylene (LDPE)), many synthetic elastomers or low polarity cyclic-olefin-copolymers (COC). The C₅ hydrocarbon resin diluent can have a weight average molecular weights of 200 to 2,500 grams per mole (g/mol) based on polystyrene standards. The C₅ hydrocarbon resin diluent can have a softening point of 85 to 115° C. (solid grades) or 5 to 10° C. (liquid grades). The C₅ hydrocarbon resin diluent can be hydrogenated to reduce discoloration and improve thermal oxidative and UV stability. Examples of C₅ hydrocarbon resin diluents are WINGTACK™ 10, WINGTACK™ 95, and WINGTACK™ 98 commercially available from Cray Valley, Exton, Pa.

The hydrocarbon resin diluent can comprise a C₈₋₉ hydrocarbon resin diluent, for example, comprising an aromatic repeat unit. The C₈₋₉ hydrocarbon resin diluent can be prepared from coal tar or crude oil distillates, for example, indene, methylindene, styrene, methylstyrene (for example, alpha-methyl styrene), or vinyl toluene. The aromatic C₈₋₉ hydrocarbon monomer can be cationically polymerized using Lewis acid catalysts to produce oligomeric resins ranging in weight average molecular weight. Compared to C₅ hydrocarbon resin diluents, aromatic C₈₋₉ hydrocarbon resin diluents can have higher melt viscosities and softening points (100 to 150° C.). Aromatic C₈₋₉ hydrocarbon resin diluents are also compatible with a variety of polymers.

The hydrocarbon resin diluent can comprise both the C₅ resin diluent and the C₈₋₉ hydrocarbon resin diluent, for example, as a blend or a co-oligomer or a copolymer thereof. Compositions of C₅ and C₈₋₉ hydrocarbon resin diluents (for example as a blend or a copolymer) can comprise 0 to 50 weight percent (wt %), or 1 to 50 wt %, or 5 to 25 wt % of aromatic repeat units based on the total weight of the diluent. Examples of aromatic C₈₋₉ modified C₅ hydrocarbon resin diluents are Wingtack™STS, Wingtack™Extra, and Wingtack™86, commercially available from Cray Valley, Exton, Pa.

The hydrocarbon resin diluent can comprise a blend or co-oligomer or copolymer of any of the disclosed hydrocarbon resin diluents. For example, the hydrocarbon resin diluent can comprise a co-oligomer or copolymer derived from petroleum-based feedstocks such as at least one of aliphatic C₅, aromatic C₉, styrene, ethylene, propylene, or butadiene. The hydrocarbon resin diluent can comprise at least one of a styrene-ethylene butadiene-styrene copolymer or styrene-propylene butadiene-styrene copolymer; that can optionally be hydrogenated. An example of such a hydrocarbon resin diluent are REGALREZ™ resins commercially available from Eastman.

The hydrocarbon resin diluent can comprise a crosslinkable elastomer. The crosslinkable elastomer can be derived from at least one of an olefin (for example, a C₂₋₈ alkene such as ethene, propene, butene, butadiene, piperylene, or isoprene) or a cyclic olefin (for example, a norbornene-type monomer comprising an unsaturated side group such as 5-vinyl-2-norbornene), with the proviso that the crosslinkable elastomer comprises at least one of an unsaturation in the backbone or an unsaturated side group. An example of a crosslinkable elastomer is one derived from ethene, propene, and dicyclopentadiene. If the composition comprises the crosslinkable elastomer comprising repeat units derived from the cyclic olefin it can be distinguished from the hydrocarbyl thermoplastic polymer in that the hydrocarbyl thermoplastic polymer can be free of a crosslinkable group or the crosslinkable elastomer can have a lower weight average molecular weight. For example, the crosslinkable elastomer can have a weight average molecular weight of 500 to 50,000 g/mol, or 500 to 10,000 g/mol or 200 to 2,500 g/mol and the hydrocarbyl thermoplastic polymer can have a weight average molecular weight of 70,000 to 105,000 g/mol based on polystyrene standards. An example of a crosslinkable ethene-propene-dicyclopentadiene elastomer is TRILENE™ 65D commercially available from Lion Elastomers, Geismar, La.

The hydrocarbon resin diluent can be distinguished from the hydrocarbyl thermoplastic polymer in that at least one of 1) the diluent can have a lower weight average molecular weight, for example, a weight average molecular weight of the diluent can be less than or equal to 60% of the weight average molecular weight of the hydrocarbyl resin diluent; 2) the diluent can have a lower heat deformation temperature point; 3) the diluent can have a lower glass transition temperature; or 4) the diluent can be reactive. One or more of these distinguishing features can enable the hydrocarbon resin diluent to have a plasticizing effect on the hydrocarbyl thermoplastic polymer and ceramic-filled versions thereof, thereby enhancing resin flow and reducing the minimum melt viscosity for the formulated system.

The hydrocarbon resin diluent can have a weight average molecular weight of 200 to 2,500 g/mol, or 1,000 to 2,200 g/mol, or 1,000 to 8,000 g/mol based on polystyrene standards. The hydrocarbon resin diluent can have a number average molecular weight of 150 to 6,000 g/mol, or 200 to 2,200 g/mol based on polystyrene standards. The composition can comprise 0 to 50 vol %, or 10 to 40 vol %, or 5 to 30 vol % of the hydrocarbon resin diluent based on the total volume of the composition.

The composition can be free of a reinforcing layer. For example, the composition can be free of a woven or a non-woven fabric. As used herein, the composition being free of the reinforcing layer can mean that it comprises 0 wt % of the reinforcing layer.

The composition can comprise a reinforcing layer. The reinforcing layer can comprise a plurality of fibers that can help control shrinkage within the plane of the composition during cure and can provide an increased mechanical strength relative to the same composite layer without the reinforcing layer. The reinforcing layer can be a woven layer or a non-woven layer. The fibers can comprise at least one of glass fibers (such as E glass fibers, S glass fibers, and D glass fibers), silica fibers, polymer fibers (such as polyetherimide fibers, polysulfone fibers, poly(ether ketone) fibers, polyester fibers, polyethersulfone fibers, polycarbonate fibers, aromatic polyamide fibers, or liquid crystal polymer fibers such as VECTRAN commercially available from Kuraray)). The fibers can have a diameter of 10 nanometers to 10 micrometers. The reinforcing layer can have a thickness of less than or equal to 200 micrometers, or 50 to 150 micrometers. The composite layer can comprise 5 to 15 volume percent, or 6 to 10 volume percent, or 7 to 11 volume percent, or 7 to 9 volume percent of the composite layer plus the reinforcing layer.

The composition can comprise an additive, for example, at least one of a ceramic filler other than the functionalized fused silica, a fire retardant, a colorant (for example, a fluorescent dye or a pigment), a plasticizer, a cure retardant, a cure accelerator, an impact modifier, an antioxidant, or a UV protector.

The additive can comprise a filler other than the functionalized fused silica. The filler can comprise at least one of fumed silica (for example, a hydrophobic fumed silica), non-functionalized fused silica, titanium dioxide, barium titanate, strontium titanate, corundum, wollastonite, Ba₂Ti₉O₂₀, zirconium tungstate, hollow ceramic spheres, boron nitride, aluminum nitride, silicon carbide, beryllia, alumina, alumina trihydrate, magnesia, mica, talc, nanoclay, or magnesium hydroxide. The filler can comprise at least one of solid glass spheres, hollow glass spheres, or core shell rubber spheres. The ceramic filler can have a D90 particle size of 0.1 to 10 micrometers, or 0.5 to 5 micrometers. The filler can have a D90 particle size of less than or equal to 2 micrometers, or 0.1 to 2 micrometers. The filler can be present in an amount of 0.1 to 10 wt %, or 0.1 to 5 wt % based on the total weight of the composition or the composite layer.

The additive can comprise a thermally conductive filler. Examples of thermally conductive fillers include aluminum nitride, boron nitride, silicon carbide, diamond, nano-diamonds, graphite, beryllium oxide, zinc oxide, zirconium silicate, magnesia, silica, or alumina.

The additive can comprise a flame retardant. The composition can comprise 5 to 25 vol %, or 8 to 20 vol % of a flame retardant based on the total volume of the composition. The flame retardant can comprise a metal hydrate, having, for example, a volume average particle diameter of 1 to 500 nanometers (nm), or 1 to 200 nm, or 5 to 200 nm, or 10 to 200 nm; alternatively the volume average particle diameter can be 500 nm to 15 micrometers, for example, 1 to 5 micrometers. The metal hydrate can comprise a hydrate of a metal, for example, at least one of Mg, Ca, Al, Fe, Zn, Ba, Cu, or Ni. Hydrates of Mg, Al, or Ca can be used, for example, at least one of aluminum hydroxide, magnesium hydroxide, calcium hydroxide, iron hydroxide, zinc hydroxide, copper hydroxide, nickel hydroxide, or hydrates of calcium aluminate, gypsum dihydrate, zinc borate, zinc stannate, or barium metaborate. Composites of these hydrates can be used, for example, a hydrate containing Mg and at least one of Ca, Al, Fe, Zn, Ba, Cu, or Ni. A composite metal hydrate can have the formula MgMₓ(OH)_{y} wherein M is Ca, Al, Fe, Zn, Ba, Cu, or Ni, x is 0.1 to 10, and y is 2 to 32. The flame retardant particles can be coated or otherwise treated to improve dispersion and other properties. The flame retardant can be reactive. The flame retardant can optionally comprise an organic halogenated flame retardant such as hexachloroendomethylenetetrahydrophthalic acid (HET acid), tetrabromophthalic acid, or dibromoneopentyl glycol. The flame retardant can optionally comprise a halogen-free flame retardant (such as melamine cyanurate), a phosphorus-containing compound (such as a phosphinate, a diphosphinate, a phosphazene, a vinyl-phosphazene, a phosphonate, a phosphaphenanthrene oxide, a fine particle size melamine polyphosphate, or a phosphate), a polysilsesquioxane, or a siloxane. The flame retardant can comprise a brominated flame retardant. The brominated flame retardant can comprise at least one of bis-pentabromophenyl ethane, ethylene bistetrabromophthalimide, tetradecabromodiphenoxy benzene, decabromodiphenyl oxide, or a brominated polysilsesquioxane. The flame retardant can be used in combination with a synergist, for example, a halogenated flame retardant can be used in combination with a synergists such as antimony trioxide.

The composition can comprise a reinforcing layer, for example, a fibrous layer. The fibrous layer can be woven or non-woven, such as a felt. The fibrous layer can comprise at least one of glass fibers or polymer-based fibers. Such thermally stable fiber reinforcement can reduce shrinkage of a layer comprising the composition upon cure within the plane of the substrate. In addition, the use of the reinforcing layer can help render a substrate with a relatively high mechanical strength.

The glass fibers can comprise at least one of E glass fibers, S glass fibers, or D glass fibers. The polymer-based fibers can comprise high temperature polymer fibers. The polymer-based fibers can comprise a liquid crystal polymer such as VECTRAN™ commercially available from Kuraray. The polymer-based fibers can comprise at least one of a polyetherimide, a polyether ketone, a polysulfone, a polyethersulfone, a polycarbonate, or a polyester.

The composition can be organically solvated (for example, in a solution comprising at least one of toluene or xylene), horizontally cast onto a release liner, and dried to form a composite layer. It is noted that the respective amounts of the components recited with respect to the composition can be directly relatable to the composite layer. For example, the composition comprising 10 to 50 vol % of the hydrocarbyl thermoplastic polymer based on the total volume of the composition can correspond to the composite layer comprising 10 to 50 vol % of the hydrocarbyl thermoplastic polymer based on the total volume of the composite layer. The release liner can have a specific surface energy of 40 to 50 dynes per centimeter. The release liner can comprise at least one of a biaxially oriented polypropylene (BOPP) or a polyester (for example, poly(ethylene terephthalate)). The release liner can comprise at least one of a silicone-treated liner (for example, polyester or a glassine paper).

The composite layer can be prepared by impregnating a reinforcing layer with the composition and an optional solvent. The impregnating can comprise at least one of coating the composition onto the reinforcing layer (for example, by at least one of casting, dip-coating, spray coating, knife-over-roll coating, knife-over-plate coating, coating via a metering rod, flow coating, roll coating, or reverse roll-coating); curing the composition to form a composite layer; and optionally drying after the impregnating.

A method of forming the composite layer can comprise forming a layer from the composition and polymerizing the reactive monomer in the composition to form a crosslinked network. The polymerizing can comprise polymerizing the reactive monomer and the functionalized fused silica to form a crosslinked network. Additionally, the polymerizing to form a crosslinked network in the composite layer can further comprise polymerizing the reactive hydrocarbon resin diluent, if present.

The polymerizing can comprise at least one of increasing a temperature of the composite layer (for example, by laminating) or exposing the composite layer to an electron-beam irradiation. The laminating can entail laminating a layered structure comprising a multilayer stack comprising the composite layer by itself or located in between two outer layers. The multilayer stack can comprise multiple, alternating layers of the composite layers and substrate layers. The multilayer stack can then be placed in a press, for example, a vacuum press, under a pressure and temperature and for duration of time suitable to form the crosslinked network within composite layers which are positioned between the substrate layers. The multilayer stack can be roll-to-roll laminated or autoclaved.

Lamination and curing can be by a one-step process, for example, using a vacuum press, or can be by a multi-step process. In a one-step process, the stack to be laminated can be placed in a press, brought to a laminating pressure and heated to a laminating temperature. The laminating temperature can be 100 to 390° C., or 100 to 250° C., or 100 to 200° C., or 100 to 175° C., or 150 to 170° C. The laminating pressure can be 1 to 3 megapascal (MPa), or 1 to 2 MPa, or 1 to 1.5 MPa. The laminating temperature and pressure can be maintained for a desired dwell (soak) time, for example, 5 to 150 minutes, or 5 to 100 minutes, 10 to 50 minutes, and thereafter cooled, optionally at a controlled cooling rate (with or without applied pressure), for example, to less than or equal to 150° C.

A circuit material comprising the composite layer can be prepared by forming a multilayer material having the composite layer with a conductive layer disposed thereon. Useful conductive layers include, for example, at least one of stainless steel, copper, gold, silver, aluminum, zinc, tin, lead, or a transition metal. There are no particular limitations regarding the thickness of the conductive layer, nor are there any limitations as to the shape, size, or texture of the surface of the conductive layer. The conductive layer can have a thickness of 3 to 200 micrometers, or 9 to 180 micrometers. When two or more conductive layers are present, the thickness of the two layers can be the same or different. The conductive layer can comprise a copper layer. Suitable conductive layers include a thin layer of a conductive metal such as a copper foil presently used in the formation of circuits, for example, electrodeposited copper foils. The copper foil can have a root mean squared (RMS) roughness of less than or equal to 2 micrometers, or less than or equal to 0.7 micrometers, where roughness is measured using a stylus profilometer.

The conductive layer can be applied by laminating the conductive layer and the composite layer, by direct laser structuring, or by adhering the conductive layer to the substrate via an adhesive layer. Other methods known in the art can be used to apply the conductive layer where permitted by the particular materials and form of the circuit material, for example, electrodeposition, chemical vapor deposition, and the like.

The laminating can entail laminating a multilayer stack comprising the composite layer, a conductive layer, and an optional intermediate layer between the composite layer and the conductive layer to form a layered structure. The conductive layer can be in direct contact with the composite layer, without the intermediate layer. The layered structure can then be placed in a press, e.g., a vacuum press, under a pressure and temperature for a duration of time suitable to bond the layers and form a laminate. Lamination and optional curing can be by a one-step process, for example, using a vacuum press, or can be by a multi-step process. In a one-step process, the layered structure can be placed in a press, brought up to laminating pressure (e.g., 1.0 to 8.3 megapascal) and heated to laminating temperature (e.g., 260 to 390° C.). The laminating temperature and pressure can be maintained for a desired soak time, for example, 20 minutes, and thereafter cooled (while still under pressure) to less than or equal to 150° C.

If present, the intermediate layer can comprise a polyfluorocarbon film that can be located in between the conductive layer and the composite layer, and an optional layer of microglass reinforced fluorocarbon polymer can be located in between the polyfluorocarbon film and the conductive layer. The layer of microglass reinforced fluorocarbon polymer can increase the adhesion of the conductive layer to the substrate. The microglass can be present in an amount of 4 to 30 weight percent (wt %) based on the total weight of the layer. The microglass can have a longest length scale of less than or equal to 900 micrometers, or less than or equal to 500 micrometers. The microglass can be microglass of the type as commercially available by Johns-Manville Corporation of Denver, Colo. The polyfluorocarbon film comprises a fluoropolymer (such as polytetrafluoroethylene, a fluorinated ethylene-propylene copolymer, and a copolymer having a tetrafluoroethylene backbone with a fully fluorinated alkoxy side chain).

The conductive layer can be applied by laser direct structuring. Here, the composite layer can comprise a laser direct structuring additive; and the laser direct structuring can comprise using a laser to irradiate the surface of the substrate, forming a track of the laser direct structuring additive, and applying a conductive metal to the track. The laser direct structuring additive can comprise a metal oxide particle (such as titanium oxide and copper chromium oxide). The laser direct structuring additive can comprise a spinel-based inorganic metal oxide particle, such as spinel copper. The metal oxide particle can be coated, for example, with a composition comprising tin and antimony (for example, 50 to 99 wt % of tin and 1 to 50 wt % of antimony, based on the total weight of the coating). The laser direct structuring additive can comprise 2 to 20 parts of the additive based on 100 parts of the respective composition. The irradiating can be performed with a YAG laser having a wavelength of 1,064 nanometers under an output power of 10 Watts, a frequency of 80 kilohertz (kHz), and a rate of 3 meters per second. The conductive metal can be applied using a plating process in an electroless plating bath comprising, for example, copper.

The conductive layer can be applied by adhesively applying the conductive layer. The conductive layer can be a circuit (the metallized layer of another circuit), for example, a flex circuit. An adhesion layer can be disposed between one or more conductive layers and the composite layer.

The composite layer can be used to adhere one or more substrate layers, for example, two substrate layers. The respective substrate layers can each independently comprise at least one of a fluoropolymer (for example, polytetrafluoroethylene (PTFE), expanded polytetrafluoroethylene (ePTFE), perfluoroalkoxy alkane (PFA)), a polyimide (such as Kapton™), a liquid-crystal polymer (LCP such as VECTRAN™), a polyester, a polyamide, a polyolefin, a polyphenylene oxide, or a conductive metal. The conductive metal can comprise at least one of silver, nickel, gold, cobalt, copper, or aluminum. The conductive metal can have a surface roughness (Rz) of less than 10 micrometers, or 1 to 10 micrometers.

The composite layers formed from the composition disclosed herein can exhibit a thermoset character due to the formation of the crosslinked network. During the polymerization of the crosslinked network, the viscosity and temperature where the film starts to soften as it goes into a minimum melt and before the cross-linker begins to pick up molecular weight can be determined and taken as the minimum melt viscosity of the composition at a corresponding temperature. The composition can have a minimum melt viscosity of greater than or equal to 80 kilopascal seconds (k-Pa·s). or 80 to 700 k-Pa·s determined using parallel plate oscillatory rheology with a ramping temperature of 5° C. per minute.

The composite layer can have a peel strength to copper of greater than or equal to 0.54 kg/cm, or 0.65 to 1.1 kg/cm measured in accordance with IPC test method 650, 2.4.8.

The composite layer can have an average coefficient of thermal expansion in the z-direction of less than or equal to 95 parts per million per degree Celsius (ppm/° C.), or less than or equal to 90 ppm/° C. from 150 to 250° C. and can be determined by ASTM D3386-00 at −125° C. to 20° C. using a 1 mil (0.0254 millimeter (mm)) thick sample.

The composite layer can have a permittivity of 2.5 to 3.5 at 10 GHz. The composite layer can have a dielectric loss of less than or equal to 0.0030, or less than or equal to 0.0021, or 0.001 to 0.0025 at 10 GHz. The dielectric loss and permittivity can be measured in accordance with the “Stripline Test for Permittivity and Loss Tangent at X-Band” test method (IPC-TM-650 2.5.5.5) at a temperature of 23 to 25° C.

The composite layer can have a UL94 V0 rating at a thickness of 84 to 760 micrometers determined in accordance with the Underwriter's Laboratory UL 94 Standard For Safety “Tests for Flammability of Plastic Materials for Parts in Devices and Appliances.”

An article can comprise the composite layer. The article can be a printed circuit board. The article can comprise a metal foil (such as copper) coated with the composite layer composition. The article can be employed in cellular telecommunications. The article can be a laminate-based chip carrier. The article can be employed in high speed digital applications.

In summary, in as aspect, a low loss composition includes 10 to 90 volume percent, or 25 to 75 volume percent, or 30 to 50 volume percent a hydrocarbyl thermoplastic polymer comprising repeat units derived from an alpha-olefin and a C₄₋₃₀ cycloalkene, preferably derived from at least one of cyclobutene, cyclopentene, cycloheptene, cyclooctene, cyclodecene, norbornene, or an alkyl- or aryl-substituted norbornene (such as 5-methyl-2-norbornene, 5-hexyl-2-norbornene, 5-phenyl-2-norbornene, 5-ethyl-2-norbornene, 4,5-dimethyl-2-norbornene, exo-1,4,4a,9,9a,10-hexahydro-9,10(1′,2′)-benzeno-1,4-methanoanthracene, exo-dihydrodicyclopentadiene, or endo,exo-tetracyclododecene), more preferably wherein the hydrocarbyl thermoplastic polymer has the Formula (I) as described herein and wherein a weight average molecular weight of the hydrocarbyl thermoplastic polymer is 500 to 105,000 grams per mole based on polystyrene standards; 1 to 35 volume percent, or 5 to 25 volume percent, or 5 to 15 volume percent a reactive monomer that is free-radically crosslinkable to produce a crosslinked network, preferably a triallyl (iso)cyanurate; an effective amount of a free radical source such as a peroxide; and 10 to 70 volume percent, or 20 to 60 volume percent a functionalized fused silica that is capable of chemically coupling to the crosslinked network, preferably wherein the functional group is at least one of a (meth)acrylate group, a vinyl group, an allyl group, a propargyl group, a butenyl group, or a styryl group, and the functionalized fused silica has a spherical morphology having an average diameter of 1 to 50 micrometers, or 1 to 10 micrometers. Optionally, 0 to 50 volume percent, or 10 to 40 volume percent, or 5 to 30 volume percent of a hydrocarbon resin diluent having a weight average molecular weight of 200 to 2,000 grams per mole based on polystyrene standards can be present, preferably wherein the hydrocarbon resin diluent is derived from piperylene and optionally an aromatic repeat unit; wherein the hydrocarbon resin diluent is optionally saturated. Optionally, 5 to 25 volume percent, or 8 to 20 volume percent of a flame retardant based on the total volume of the composition can be present.

A composite layer derived from the foregoing composition can have a minimum melt viscosity of greater than or equal to 80 kilopascal seconds, or 80 to 700 kilopascal seconds; a peel strength to copper of greater than or equal to 0.54 kilograms per centimeter; an average coefficient of thermal expansion in the z-direction of less than or equal to 95 parts per million per degree Celsius, or less than or equal to 90 parts per million per degree Celsius from 150 to 250 degrees Celsius; a permittivity of 2.5 to 3.5 at 10 gigahertz; and a dielectric loss of less than or equal to 0.0030, or less than or equal to 0.0021, or 0.001 to 0.0025 at 10 gigahertz. A multilayer article is disclosed comprising the composite layer adhered to the low profile side of an electrically conductive layer, such as a low profile copper layer.

The following examples are provided to illustrate the present disclosure. The examples are merely illustrative and are not intended to limit devices made in accordance with the disclosure to the materials, conditions, or process parameters set forth therein.

### EXAMPLES

In the examples, the minimum melt viscosity (MMV) was determined using parallel plate oscillatory rheology with a ramping temperature of 5° C. per minute. The viscosity and temperature where the film starts to soften as it goes into a minimum melt and before the cross-linker begins to pick up molecular weight is taken as the minimum melt viscosity and corresponding temperature. The units of the minimum melt viscosity are noted in kilopascal seconds (k-Pa·s)

The permittivity (Dk) and the dissipation loss (Df) (also referred to as the loss tangent) were measured in accordance with the “Stripline Test for Permittivity and Loss Tangent at X-Band” test method (IPC-TM-650 2.5.5.5) at a temperature of 23 to 25° C.

The glass transition temperature (Tg) and the coefficients of thermal expansion (CTE) in the z-direction were determined in accordance with the “Glass Transition Temperature and Thermal Expansion of Materials Used in High Density Interconnection (HDI) and Microvias-TMA Method” (IPC-TM-650 2.4.24.5).

The copper roughness was determined using atomic force microscopy in contact mode and is reported as Rz in micrometers calculated by determining the sum of five highest measured peaks minus the sum of the five lowest valleys and then dividing by five (JIS (Japanese Industrial Standard)-B-0601); or the copper roughness was determined using white light scanning interferometry in contactless mode and is reported as Sa, Sq, Sz height parameters in micrometers using a stitching technique to characterize treated-side surface topography and texture (ISO 25178).

The copper peel strength was determined in accordance with the “Peel Strength of Metallic Clad Laminates” test method (IPC-TM-650 2.4.8). When testing the peel strength, a stack of each of the composite layer along with a ½ ounce copper foil as indicated in Table 1 located on either side of the composite layer was laminated using the typical epoxy cure cycle of 90 minutes at 185° C. at a pressure of 1.7 megapascal (MPa). In the examples, the copper clad laminates were tested for peel strength after-solder (AS). The ½ ounce copper foil refers to the thickness of the copper layer achieved when a ½ ounce (18.8 mm) of copper is pressed flat and spread evenly over a one square foot (929 centimeters squared) area. The equivalent thickness is 0.01735 mm

The components used in the examples are shown in Table 1.

TABLE 1

| | | |
|---|---|---|
| Olefin copolymer | TOPAS ™ 5013S-04, Cyclic olefin copolymer (COC) having a | TOPAS |
| | relative permittivity of 2.35 measured in accordance with IEC | Advanced |
| | 60250 at 1-10 kHz | Polymers |
| | | GmbH |
| TAIC | Triallyl isocyanurate | Evonik |
| Initiator | 2,5-dimethyl-2,5-di(t-butylperoxy)-3-hexyne | Evonik |
| Fused silica | Spherical fused silica, grade FB-85, median diameter of 8 | Denka |
| | micrometers from Denka | |
| m-Fused silica | Spherical fused silica, grade FB-8S, median diameter of 8 | Modified |
| | micrometers from Denka, methacrylated at Rogers | Denka |
| Flame retardant | Saytex ™ 8010; bis-pentabromophenyl ethane | Albemarle |
| Cu foil 1 | Copper foil (MLS) reverse-side treated (RT) having a treated | Oak-Mitsui |
| | side roughness of 3.5 to 5.5 micrometers (Rz) | |
| Cu foil 2 | Standard quality, very low profile copper foil layer (SQ-VLP) | Oak-Mitsui |
| | having a very low profile treated side roughness of 2 to 3 | |
| | micrometers (Rz) | |
| Cu foil 3 | TWS copper foil layer (TWS) having a low profile treated side | Circuit Foil |
| | roughness of 7 to 10 micrometers (Rz) | Luxembourg |
| Hydrocarbon | WINGTACK ™ 98, a 0 wt % aromatically modified aliphatic C₅ | TOTAL |
| resin diluent 1 | hydrocarbon having a weight average molecular weight of | Cray |
| | 1,700-2,000 g/mol. | Valley |
| Hydrocarbon | WINGTACK ™ Extra, a 9 wt % aromatically modified C₅ | TOTAL |
| resin diluent 2 | hydrocarbon having a weight average molecular weight of | Cray |
| | 2,000 g/mol. | Valley |
| Hydrocarbon | WINGTACK ™ STS, a 24 wt % aromatically modified C₅ | TOTAL |
| resin diluent 3 | hydrocarbon having a weight average molecular weight of | Cray |
| | 1,600 g/mol. | Valley |
| Hydrocarbon | REGALREZ ™ 1126, produced by polymerization and | Eastman |
| resin diluent 4 | hydrogenation of pure monomer hydrocarbon feed-stocks | |
| | having a weight average molecular weight of 1,300 g/mol. | |

### EXAMPLES 1-8

### Effect of the Methacrylated Fused Silica

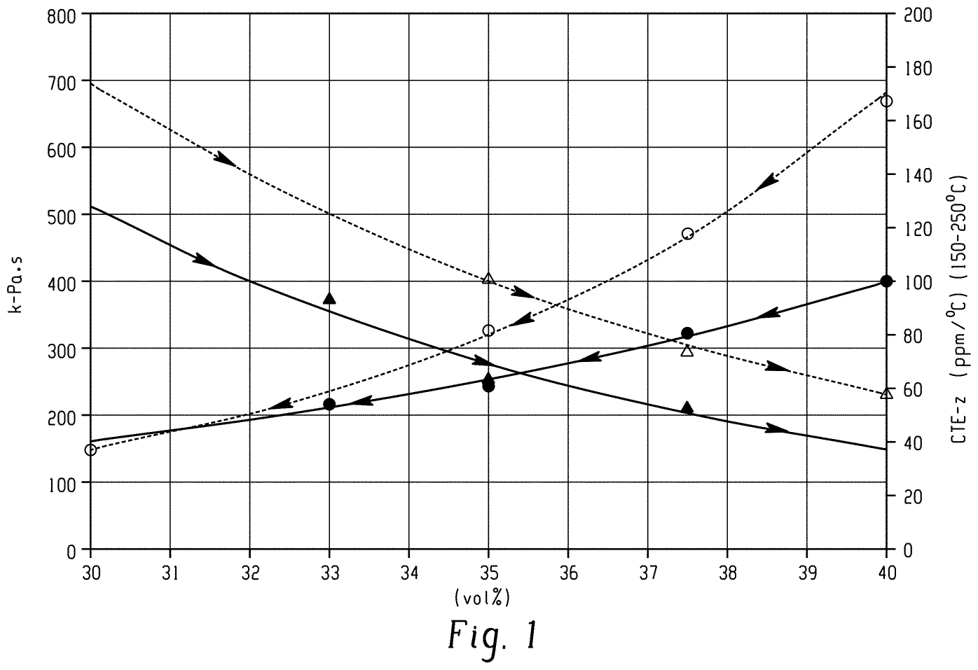

Composite layers were prepared by first mixing the components as shown in Table 2. The reactive compositions were then horizontally cast onto a silicone release liner. The resultant dielectric film layers had a thickness of 75 micrometers (3 mils). Minimum melt viscosities were determined and the results are shown in Table 2 and FIG. 1, where the open symbols are of the fused silica and the filled in symbols are of the m-fused silica. Twenty (20) composite layers were then laminated using the typical epoxy cure cycle of 90 minutes at 185° C. at a pressure of 1.7 megapascal (MPa). The coefficient of thermal expansion values were determined and the results are shown in Table 2 and FIG. 1. The dielectric properties were determined at a thickness of 1,500 micrometers (60 mils) and are also shown in Table 2.

TABLE 2

| Example | 1 | 2 | 3 | 4 | 5 | 6 | 7 | 8 |
|---|---|---|---|---|---|---|---|---|
| Olefin copolymer | 46.4 | 44.1 | 42.4 | 42.4 | 40.6 | 40.6 | 38.6 | 38.6 |
| (vol %) | | | | | | | | |
| TAIC | 13.6 | 12.7 | 12.2 | 12.2 | 11.4 | 11.4 | 10.7 | 10.7 |
| (vol %) | | | | | | | | |
| Initiator | 1.5 | 1.5 | 1.5 | 1.5 | 1.5 | 1.5 | 1.5 | 1.5 |
| (vol %) | | | | | | | | |
| Fused | 30.0 | — | 35.0 | — | 37.5 | — | 40.0 | — |
| silica (vol %) | | | | | | | | |
| m-Fused | — | 33.0 | — | 35.0 | — | 37.5 | — | 40.0 |
| silica (vol %) | | | | | | | | |
| Flame | 8.5 | 8.7 | 8.9 | 8.9 | 9.0 | 9.0 | 9.2 | 9.2 |
| retardant (vol %) | | | | | | | | |

Properties

| | | | | | | | | |
|---|---|---|---|---|---|---|---|---|
| Dk at 10 GHz | 2.89 | 2.82 | 2.91 | 2.86 | 2.94 | 2.96 | — | — |
| Df at 10 GHz | 0.0019 | 0.0027 | 0.0023 | 0.0023 | 0.0024 | 0.0018 | — | — |
| Average CTE-z from | — | 93 | 102 | 63 | 74 | 53 | 59 | — |
| 150 to 250° C. | | | | | | | | |
| (ppm/° C.) | | | | | | | | |
| MMV (k-Pa·s) | 148 | 217 | 328 | 243 | 471 | 322 | 670 | 401 |
| Cu foil 1 | 4.1; | 4.1; | — | 4.0; | — | 3.3; | — | — |
| (pli; kg/cm) | 0.73 | 0.73 | | 0.71 | | 0.59 | | |
| Cu foil 3 | 4.7; | 6.1; | — | 4.9; | — | 5.8; | — | — |
| (pli; kg/cm) | 0.84 | 1.09 | | 0.88 | | 1.04 | | |

Table 2 and FIG. 1 show that replacing the fused silica with a methacrylated fused silica resulted in a surprising decrease in both the minimum melt viscosity and the coefficient of thermal expansion in the z-direction, while maintaining good copper peel strengths.

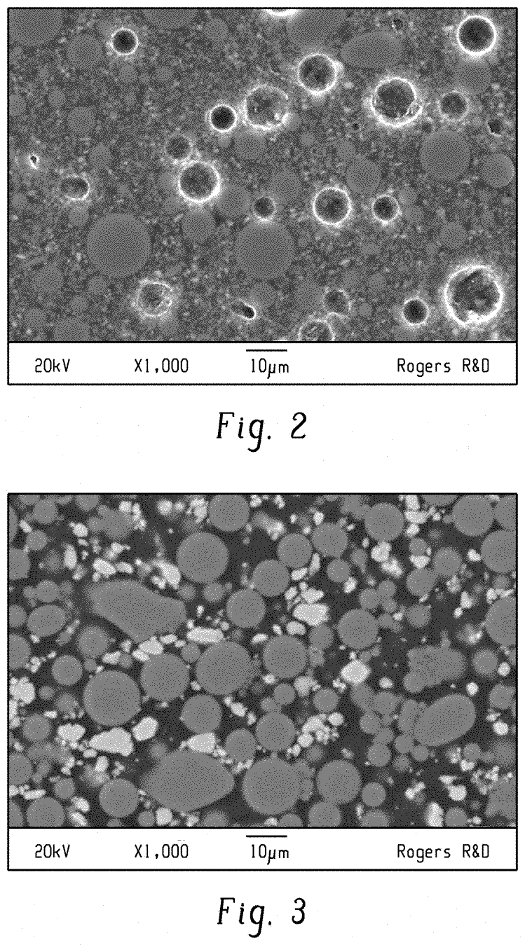

Without being bound by theory, it is believed that treating the fused silica with a functional silane served to couple the inorganic silica to the organic isocyanurate-based thermoset. Evidence for this coupling is shown in FIG. 2 and FIG. 3. FIG. 2 is a scanning electron microscope of a composition comprising the untreated fused silica after polishing. FIG. 2 clearly shows the presence of spherical voids on the surface where the fused silica particles were removed (not bound) during the polishing step. In contrast, FIG. 3 is a scanning electron microscope of a composition comprising the methacrylated fused silica after polishing. FIG. 3 clearly shows that the methacrylated fused silica particles were not removed during the polishing step and are still bound to (present in) the composition.

### EXAMPLES 9-11

### Effect of Methacrylated Fused Silica on Peel Strength

The composite layers of Examples 9-11 comprising 33.0 to 37.5 vol % of the methacrylated fused silica were prepared in accordance with Examples 1-8 and are shown in Table 3. Various properties were determined, and the results are also shown in Table 3 and Table 4.

TABLE 3

| Example | 9 | 10 | 11 |
|---|---|---|---|
| Olefin copolymer (vol %) | 44.1 | 42.4 | 40.3 |
| TAIC (vol %) | 12.7 | 12.2 | 11.6 |
| Initiator (vol %) | 1.5 | 1.5 | 1.5 |
| m-Fused silica (vol %) | 33.0 | 35.0 | 37.5 |
| Flame retardant (vol %) | 8.7 | 8.9 | 9.1 |
| Total Filler (vol %) | 41.7 | 43.9 | 46.6 |

Properties

| | | | |
|---|---|---|---|
| Dk at 10 GHz | 2.821 | 2.849 | 2.958 |
| Df at 10 GHz | 0.0027 | 0.0023 | 0.0018 |
| Tg (° C.) | 124 | 126 | 144 |
| Average CTE-z from 50 to | 30 | 28 | 23 |
| 150° C. (ppm/° C.) | | | |
| Average CTE-z from 150 to | 127 | 53 | 63 |
| 250° C. (ppm/° C.) | | | |
| Average CTE-z from 50 to | 65 | 36 | 35 |
| 250° C. (ppm/° C.) | | | |
| Cu foil 1-Peel (pli; kg/cm) | 4.1; 0.73 | 3.5; 0.63 | 3.3; 0.59 |
| Cu foil 2-Peel (pli; kg/cm) | 4.9; 0.88 | 4.0; 0.71 | 5.2; 0.93 |
| Cu foil 3-Peel (pli; kg/cm) | 6.1; 1.09 | 4.6; 0.82 | 5.8; 1.04 |
| MMV (k-Pa·s) | 217 | 243 | 461 |
| MMV (° C.) | 166 | 163 | 174 |

Table 3 shows the layers of Examples 9-11 advantageously exhibited high copper peel strengths of greater than 3 pli (0.54 kg/cm) to all of the copper foils tested as the volume loading of the methacrylated fused silica was increased to reduce CTE in the z-axis.

The dielectric properties of Examples 9-11 were determined on laminates at varying thicknesses comprising plies of the composite layer. The results are shown in Table 4.

TABLE 4

| Example | 9 | | | 10 | | | 11 | | |
|---|---|---|---|---|---|---|---|---|---|
| m-Fused | 33 | 33 | 33 | 35 | 35 | 35 | 37.5 | 37.5 | 37.5 |
| silica (vol %) | | | | | | | | | |
| Thickness | 229 | 305 | 508 | 229 | 305 | 508 | 229 | 305 | 508 |
| (micrometers) | | | | | | | | | |

Properties

| | | | | | | | | | |
|---|---|---|---|---|---|---|---|---|---|
| Dk at 10 GHz | 2.84 | 2.80 | 2.96 | 2.90 | 2.85 | 2.98 | 2.94 | 3.05 | 3.01 |
| Df at 10 GHz | 0.0019 | 0.0020 | 0.0022 | 0.0019 | 0.0020 | 0.0016 | 0.0019 | 0.0021 | 0.0021 |

Table 4 shows that the laminates comprising composite layers of Examples 9-11 exhibited good permittivity values and low loss values at 10 GHz.

### EXAMPLES 12-16

### Effect of the Hydrocarbon Resin Diluent on the Composite Layer

### Examples 12-16 as shown in Table 5 were prepared in accordance with Examples 1-8 except that different diluents were added. The respective properties were determined and are also shown in Table 5.

TABLE 5

| Example | 12 | 13 | 14 | 15 | 16 |
|---|---|---|---|---|---|
| Olefin copolymer (vol %) | 42.4 | 41.6 | 40.9 | 39.2 | 39.2 |
| TAIC (vol %) | 12.2 | 12.0 | 11.7 | 11.4 | 11.4 |
| Initiator (vol %) | 1.5 | 1.5 | 1.5 | 1.5 | 1.5 |
| m-Fused silica (vol %) | 35.0 | 35.0 | 35.0 | 35.0 | 35.0 |
| Hydrocarbon resin diluent 1 | — | — | — | — | 4.0 |
| Hydrocarbon resin diluent 2 | — | — | — | 4.0 | — |
| Hydrocarbon resin diluent 3 | — | 1.0 | 2.0 | — | — |
| Flame retardant (vol %) | 8.9 | 8.9 | 8.9 | 8.9 | 8.9 |

Properties

| | | | | | |
|---|---|---|---|---|---|
| Dk at 10 GHz | 2.86 | 2.95 | 2.93 | 2.92 | 2.92 |
| Df at 10 GHz | 0.0023 | 0.0022 | 0.0027 | 0.0018 | 0.0021 |
| Average CTE-z from 150 to | 63 | 47 | 71 | 46 | 67 |
| 250° C. (ppm/° C.) | | | | | |
| MMV (k-Pa·s) | 243 | 116 | 118 | 55 | 55 |
| Cu foil 1-Peel (pli; kg/cm) | 4.0; 0.71 | 3.9; 0.70 | 3.7; 0.66 | 4.0; 0.71 | 3.7; 0.66 |
| Cu foil 3-Peel (pli; kg/cm) | 4.9; 0.88 | 4.7; 0.84 | 4.5; 0.80 | 4.8; 0.86 | 4.6; 0.82 |

Table 5 shows that the addition of the hydrocarbon resin diluent resulted in a significant decrease in minimum melt viscosity, while maintaining good CTE values and dielectric properties. It follows that the addition of hydrocarbon resin diluents represents a means of enhancing resin fill-and-flow without adversely affecting plated-through-hole thermal reliability performance.

Examples 17-20 as shown in Table 6 were prepared in accordance with Examples 1-8 except that different diluents were added. The respective properties were determined and are also shown in Table 6.

TABLE 6

| Example | 17 | 18 | 19 | 20 |
|---|---|---|---|---|
| Olefin copolymer (vol %) | 42.4 | 41.6 | 40.9 | 39.4 |
| TAIC (vol %) | 12.2 | 12.0 | 11.7 | 11.2 |
| Initiator (vol %) | 1.5 | 1.5 | 1.5 | 1.5 |
| m-Fused silica (vol %) | 35.0 | 35.0 | 35.0 | 35.0 |
| Hydrocarbon resin diluent 2 | — | — | 2.0 | — |
| Hydrocarbon resin diluent 3 | — | 1.0 | — | — |
| Hydrocarbon resin diluent 4 | — | — | — | 4.0 |
| Flame retardant (vol %) | 8.9 | 8.9 | 8.9 | 8.9 |

Properties

| | | | | |
|---|---|---|---|---|
| Dk at 10 GHz | 2.90 | 2.95 | 2.94 | 2.93 |
| Df at 10 GHz | 0.0022 | 0.0022 | 0.0020 | 0.0030 |
| Average CTE-z from 150 to 250° C. | 76 | 47 | 73 | 98 |
| (ppm/° C.) | | | | |
| Hole Fill, 1, 2 plies, % | 20, 65-70 | — | 30-35, 75-80 | 30-35, 100 |
| MMV (k-Pa·s) | 192 | 116 | 122 | 113 |
| Cu foil 1-Peel (pli; kg/cm) | 3.8; 0.68 | 3.9; 0.70 | 3.7; 0.66 | 3.6; 0.64 |
| Cu foil 3-Peel (pli; kg/cm) | 4.7; 0.84 | 4.7; 0.84 | 4.6; 0.82 | 4.4; 0.79 |

Table 6 shows that the addition of the hydrocarbon resin diluent resulted in a significant decrease in minimum melt viscosity, an improvement in hole-fill performance used as an indicator for resin fill-and-flow ability while maintaining good CTE values and dielectric properties.

Set forth below are non-limiting aspects of the present disclosure.

Aspect 1: A composition comprising: a hydrocarbyl thermoplastic polymer comprising repeat units derived from an alpha-olefin and a C₄₋₃₀ cycloalkene; a reactive monomer which is free-radically crosslinkable to produce a crosslinked network; a free radical source; and a functionalized fused silica capable of chemically coupling to the crosslinked network.

Aspect 2: The composition of Aspect 1, wherein the hydrocarbyl thermoplastic polymer comprises repeat units derived from at least one of cyclobutene, cyclopentene, cycloheptene, cyclooctene, cyclodecene, norbornene, or an alkyl- or aryl-substituted norbornene (such as 5-methyl-2-norbornene, 5-hexyl-2-norbornene, 5-phenyl-2-norbornene, 5-ethyl-2-norbornene, 4, 5-dimethyl-2-norbornene, exo-1,4,4a,9,9a,10-hexahydro-9,10(1′,2′)-benzeno-1,4-methanoanthracene, exo-dihydrodicyclopentadiene, or endo,exo-tetracyclododecene).

Aspect 3: The composition of any one or more of the preceding aspects, wherein the hydrocarbyl thermoplastic polymer has the Formula (I).

Aspect 4: The composition of any one or more of the preceding aspects, wherein a molar ratio of the C₄₋₃₀ cycloalkene repeat units to the alpha-olefin repeat units to is 6:1 to 0.5:1, or 6:1 to 1.5:1.0.

Aspect 5: The composition of any one or more of the preceding aspects, wherein a weight average molecular weight of the hydrocarbyl thermoplastic polymer is 500 to 105,000 grams per mole based on polystyrene standards.

Aspect 6: The composition of any one or more of the preceding aspects, wherein the composition comprises 10 to 90 volume percent, or 25 to 75 volume percent, or 30 to 50 volume percent of the hydrocarbyl thermoplastic polymer based on the total volume of the composition. The hydrocarbyl thermoplastic polymer can be non-reactive with the other components of the composition.

Aspect 7: The composition of any one or more of the preceding aspects, wherein the reactive monomer comprises a triallyl (iso)cyanurate.

Aspect 8: The composition of any one or more of the preceding aspects, wherein the composition comprises 1 to 35 volume percent, or 5 to 25 volume percent, or 5 to 15 volume percent of the reactive monomer based on the total volume of the composition.

Aspect 9: The composition of any one or more of the preceding aspects, wherein the free radical source comprises at least one of a peroxide, dimethyl diphenyl hexane, methyl ethyl ketone peroxide, cyclohexanone peroxide, 1,1-bis(t-butyl peroxy)-3,3,5-trimethylcyclohexane, 2,2-bis(t-butyl peroxy)butane), t-butyl hydroperoxide, 2,5-dimethylhexane-2,5-dihydroperoxide, 2,5-dimethyl-2,5-di(t-butyl peroxy)hexyne-3, t-butyl perbenzoate, α,α′-di-(t-butyl peroxy) diisopropylbenzene, or 2,5-dimethyl-2,5-di(t-butylperoxy)-3-hexyne, α,α′-bis(t-butyl peroxy-m-isopropyl)benzene), octanoyl peroxide, isobutyryl peroxide), peroxydicarbonate, a,a′-azobis(isobutyronitrile), a redox initiator, acetyl azide, 2,3-dimethyl-2,3-diphenylbutane, 3,4-dimethyl-3,4-diphenylhexane, or 1,4-diisopropylbenzene; and/or wherein the composition comprises 0.1 to 2 volume percent, or 0.5 to 1 volume percent of the free radical source based on the total weight of the composition.

Aspect 10: The composition of any one or more of the preceding aspects, wherein the functionalized fused silica has a spherical morphology having an average diameter of 1 to 50 micrometers, or 1 to 10 micrometers.

Aspect 11: The composition of any one or more of the preceding aspects, wherein the composition comprises 10 to 70 volume percent, or 20 to 60 volume percent, or 40 to 55 volume percent of the functionalized fused silica based on the total volume of the composition.

Aspect 12: The composition of any one or more of the preceding aspects, further comprising a hydrocarbon resin diluent having a weight average molecular weight of 200 to 2,000 grams per mole based on polystyrene standards.

Aspect 13: The composition of any one or more of the preceding aspects, further comprising a hydrocarbon resin diluent; wherein the hydrocarbon resin diluent is derived from piperylene and optionally an aromatic repeat unit; wherein the hydrocarbon resin diluent is optionally saturated.

Aspect 14: The composition of any one or more of the preceding aspects, wherein the composition comprises 0 to 50 volume percent, or 10 to 40 volume percent, or 5 to 30 volume percent of the hydrocarbon resin diluent based on the total volume of the composition.

Aspect 15: The composition of any one or more of the preceding aspects, further comprising 5 to 25 volume percent, or 8 to 20 volume percent of a flame retardant based on the total volume of the composition.

Aspect 16: A composite layer derived from the composition of any one or more of the preceding aspects.

Aspect 17: The composite layer of Aspect 16 having one or more of the following properties. The composition can have a minimum melt viscosity of greater than or equal to 80, or 80 to 700 k-Pa·s. The composite layer can have a peel strength to copper of greater than or equal to 0.54 kg/cm. The composite layer can have an average coefficient of thermal expansion in the z-direction of less than or equal to 95 ppm/° C., or less than or equal to 90 ppm/° C. from 150 to 250 ° C. The composite layer can have a permittivity of 2.5 to 3.5 at 10 GHz. The composite layer can have a dielectric loss of less than or equal to 0.0030, or less than or equal to 0.0021, or 0.001 to 0.0025 at 10 GHz.

Aspect 18: A method of making a composite layer, for example, of Aspects 16 and 17 comprising: forming a layer from the composition of any one or more of Aspects 1 to 15; and polymerizing the reactive monomer in the composition to form a crosslinked network.

Aspect 19: The method of Aspect 18, wherein the polymerizing comprises at least one increasing a temperature of the layer, exposing the layer to an ultraviolet radiation, or exposing the layer to an electron-beam irradiation.

Aspect 20: The method of any one or more of Aspects 18 to 19, wherein the forming the layer comprises casting the composition on a release liner.

Aspect 21: The method of any one or more of Aspects 18 to 19, wherein the forming the layer comprises casting the composition on a metal foil such as copper or aluminum.

Aspect 22: The method of any one or more of Aspects 18 to 21, wherein the forming the layer comprises impregnating a reinforcing layer with the composition. The impregnating can comprise at least one of casting the composition onto the reinforcing layer, dip-coating the reinforcing layer into the composition, or roll-coating the composition onto the reinforcing layer.

Aspect 23: A multilayer article comprising the composite layer of any one or more of Aspects 16 to 22.

Aspect 24: The composition of any one or more of the preceding aspects, wherein a functional group of the functionalized fused silica comprises at least one of a (meth)acrylate group, a vinyl group, an allyl group, a propargyl group, a butenyl group, or a styryl group.

Aspect 25: The composition of any one or more of the preceding aspects, wherein the functionalized fused silica was derived from a functional silane comprising at least one of (3-acryloxypropyl)trimethoxy-silane, n-(3-acryloxy-2-hydroxypropyl)-3-aminopropyltriethoxysilane, (3-acryloxypropyl)methyldimethoxysilane, methacryloxypropyltrimethoxysilane, o-(methacryloxyethyl)-n-(triethoxy-silylpropyl)urethane, n-(3-methacryloxy-2-hydroxypropyl)-3-aminopropyltriethoxysilane, methacryloxymethyltriethoxysilane, methacryloxymethyltrimethoxysilane, methacryloxypropyltriethoxysilane, (methacryloxymethyl)methyldiethoxysilane, (methacryloxymethyl)methyldimethoxysilane, methacryloxypropylmethyldiethoxysilane, methacryloxypropylmethyldimethoxysilane, methacryloxypropyldimethylethoxysilane, methacryloxypropyldimethylmethoxysilane, vinyltriacetoxysilane, vinyltriethoxysilane, vinyltriisopropenoxysilane, vinyltriisopropoxysilane, vinyltrimethoxysilane, vinyltris(2-methoxyethoxy)silane, vinyltris(methylethylketoximino)silane, (divinylmethylsilylethyl)triethoxysilane, docosenyltriethoxysilane, hexadecafluorododec-11-enyl-1-trimethoxysilane, hexenyltriethoxysilane, 7-octenyltrimethoxysilane, 0-undecenyltrimethoxysilane, o-(vinyloxybutyl)-n-(triethoxysilyl-propyl)urethane, vinyltri-t-butoxysilane, vinyltris(methoxypropoxy)silane, vinylmethyldiethoxysilane, vinylmethyldimethoxysilane, vinyldimethylethoxysilane, trivinylmethoxysilane, bis(triethoxysilylethyl)vinylmethyl-silane, triethoxysilyl modified poly-1,2-butadiene, diethoxymethylsilyl modified poly-1,2-butadiene, 3-(n-allylamino)propyltrimethoxy silane, n-allyl-aza-2,2-dimethoxysilacyclopentane, allyltrimethoxysilane, allyloxyundecyltrimethoxysilane, allyltriethoxysilane, 2-(chloromethyl)allyltrimethoxysilane, o-(propargyloxy)-n-(triethoxy-silylpropyl)urethane, butenyltriethoxysilane, 3-(n-styrylmethyl-2-aminoethylamino)propyltrimethoxysilane, styrylethyltrimethoxysilane, (3-cyclopentadienylpropyl)trimethoxysilane, [2-(3-cyclohexenyl)ethyl]trimethoxysilane, or [2-(3-cyclohexenyl)ethyl]trimethoxysilane. The functional silane can comprise at least one of a methacrylsilane such as at least one of γ-methacryloxypropyl methyldimethoxy silane, γ-methacryloxypropyl trimethoxy silane, γ-methacryloxypropyl methyldiethoxy silane, or γ-methacryloxypropyl triethoxy silane.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The terms “a” and “an” do not denote a limitation of quantity, but rather denote the presence of at least one of the referenced item. The term “or” means “and/or” unless clearly indicated otherwise by context. Reference throughout the specification to “an aspect”, “an aspect”, “another aspect”, “some aspects”, and so forth, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present. It is understood that the present composite layer can be directly on one or more substrate layers.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to 25 wt %, or 5 to 20 wt %” is inclusive of the endpoints and all intermediate values of the ranges of “5 to 25 wt %,” such as 10 to 23 wt %, etc.).

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A composition comprising:
a hydrocarbyl thermoplastic polymer comprising repeat units derived from an alpha-olefin and a C₄₋₃₀ cycloalkene;
a reactive monomer that is free-radically crosslinkable to produce a crosslinked network;
a free radical source; and
a functionalized fused silica that is capable of chemically coupling to the crosslinked network;
wherein the composition optionally has a minimum melt viscosity of greater than or equal to 80 kilopascal seconds as determined using parallel plate oscillatory rheology with a ramping temperature of 5° C. per minute.

2. The composition of claim 1, wherein the hydrocarbyl thermoplastic polymer comprises repeat units derived from at least one of cyclobutene, cyclopentene, cycloheptene, cyclooctene, cyclodecene, norbornene, or an alkyl- or aryl-substituted norbornene.

3. The composition of claim 1, wherein the hydrocarbyl thermoplastic polymer has the Formula (I), 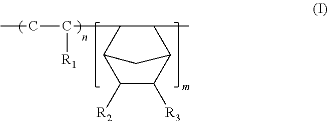
wherein R₁, R₂, and R₃ are each independently H, a C₁₋₃₀ alkyl group, a C₆₋₃₀ aryl group; n is 10 to 3,500; and m is to 1 to 5,300.

4. The composition of claim 1, wherein a molar ratio of the C₄₋₃₀ cycloalkene repeat units to the alpha-olefin repeat units to is 6:1 to 0.5:1.

5. The composition of claim 1, wherein the composition comprises 10 to 90 volume percent of the hydrocarbyl thermoplastic polymer based on the total volume of the composition.

6. The composition of claim 1, wherein the reactive monomer comprises a triallyl (iso)cyanurate.

7. The composition of claim 1, wherein the composition comprises 1 to 35 volume percent of the reactive monomer based on the total volume of the composition.

8. The composition of claim 1, wherein the free radical source comprises at least one of dicumyl peroxide, dimethyl diphenyl hexane, methyl ethyl ketone peroxide, cyclohexanone peroxide, 1,1-bis(t-butyl peroxy)-3,3,5-trimethylcyclohexane, 2,2-bis(t-butyl peroxy)butane), t-butyl hydroperoxide, 2,5-dimethylhexane-2,5-dihydroperoxide, 2,5-dimethyl-2,5-di(t-butyl peroxy)hexyne-3, t-butyl perbenzoate, α,α′-di-(t-butyl peroxy) diisopropylbenzene, or 2,5-dimethyl-2,5-di(t-butylperoxy)-3-hexyne, α,α′-bis(t-butyl peroxy-m-isopropyl)benzene), octanoyl peroxide, isobutyryl peroxide), peroxydicarbonate, α,α′-azobis(isobutyronitrile), a redox initiator, acetyl azide, 2,3-dimethyl-2,3-diphenylbutane, 3,4-dimethyl-3,4-diphenylhexane, or 1,4-diisopropylbenzene; and/or wherein the composition comprises 0.1 to 2 volume percent of the free radical source based on the total weight of the composition.

9. The composition of claim 1, wherein the functionalized fused silica has a spherical morphology having an average diameter of 1 to 50 micrometers.

10. The composition of claim 1, wherein the composition comprises 10 to 70 volume percent of the functionalized fused silica based on the total volume of the composition.

11. The composition of claim 1, further comprising a hydrocarbon resin diluent; wherein the hydrocarbon resin diluent is derived from piperylene and optionally an aromatic repeat unit.

12. The composition of claim 1, further comprising 5 to 25 volume percent of a flame retardant based on the total volume of the composition.

13. The composition of claim 1, wherein a functional group of the functionalized fused silica comprises at least one of a (meth)acrylate group, a vinyl group, an allyl group, a propargyl group, a butenyl group, or a styryl group.

14. A composite layer derived from the composition of claim 1, wherein the composite layer has at least one of
a peel strength to copper of greater than or equal to 0.54 kilograms per centimeter;
an average coefficient of thermal expansion in the z-direction of less than or equal to 95 parts per million per degree Celsius;
a permittivity of 2.5 to 3.5 at 10 gigahertz; or
a dielectric loss of less than or equal to 0.0030 at 10 gigahertz.

15. A multilayer article comprising the composite layer of claim 14.

16. A composition comprising:
10 to 90 volume percent of a hydrocarbyl thermoplastic polymer having the Formula (I), 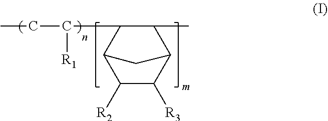
wherein R₁, R₂, and R₃ are each independently H, a C₁₋₃₀ alkyl group, a C₆₋₃₀ aryl group; n is 10 to 3,500; and m is to 1 to 5,300; wherein a molar ratio of the C₄₋₃₀ cycloalkene repeat units to the alpha-olefin repeat units to is 6:1 to 0.5:1;
1 to 35 volume percent of a triallyl (iso)cyanurate that is free-radically crosslinkable to produce a crosslinked network;
0.1 to 2 volume percent of a free radical source; and
10 to 70 volume percent of a functionalized fused silica that is capable of chemically coupling to the crosslinked network;
wherein the volume percents are based on the total volume of the composition.

17. A method of making a composite layer comprising:
forming a layer from a composition; and
polymerizing the reactive monomer in the composition to form the crosslinked network;
wherein the composition comprises:
a hydrocarbyl thermoplastic polymer comprising repeat units derived from an alpha-olefin and a C₄₋₃₀ cycloalkene;
a reactive monomer that is free-radically crosslinkable to produce a crosslinked network;
a free radical source; and
a functionalized fused silica that is capable of chemically coupling to the crosslinked network.

18. The method of claim 17, wherein the polymerizing comprises at least one increasing a temperature of the layer or exposing the layer to an electron-beam irradiation.

19. The method of claim 17, wherein the forming the layer comprises casting the composition on a release liner; or wherein the forming the layer comprises casting the composition on a metal foil.

20. The method of claim 17, wherein the forming the layer comprises impregnating a reinforcing layer with the composition.
